(19) United States
(12) Patent Application Publication
(10) Pub. No.: US 2015/0169576 A1
(43) Pub. Date: Jun. 18, 2015

(54) Dynamic Search Results

(71) Applicant: Google Inc., (US)

(72) Inventor: Navneet Panda, Mountain View, CA (US)

(73) Assignee: Google Inc., Mountain View, CA (US)

(21) Appl. No.: 13/788,773

(22) Filed: Mar. 7, 2013

Related U.S. Application Data
(60) Provisional application No. 61/758,589, filed on Jan. 30, 2013.

(51) Int. Cl. G06F 17/30

(52) U.S. Cl. CPC G06F 17/3053

(57) ABSTRACT

Methods, systems, and apparatus, including computer programs encoded on computer storage media, for providing dynamic search results. One of the methods includes providing an ordered plurality of first search results to a client device at a first point in time wherein the first search results are responsive to a first query received from the client device. At a second point in time following the first point in time, a lack of selection of any of the first search results by a user of the client device. In response to the detecting, providing the second search results to the client device before selection of any of the first search results by the user of the client device.

### CROSS-REFERENCE TO RELATED APPLICATIONS

This application claims the benefit under 35 U.S.C. §119(e) of the filing date of U.S. Patent Application No. 61/758,589, for Dynamic Search Results, which was filed on Jan. 30, 2013, and which is incorporated here by reference.

### BACKGROUND

This specification generally relates to providing search results to users. Internet search engines aim to identify resources (e.g., web pages, images, text documents, multimedia content) that are relevant to a user's needs and to present information about the resources in a manner that is most useful to the user. Internet search engines return a set of search results in response to a user submitted query.

### SUMMARY

Systems and techniques are described for estimating, for a set of ordered search results provided to a user in response to query, how many of the top-ranked search results the user has viewed at a given point in time since submission of the query and before the user has selected any of the search results. Information associated with the viewed search results can be used to refine the search results on the fly based on the assumption that the viewed search results were not particularly relevant to the user. For example, weights associated with one or more terms of the submitted query can be adjusted to reflect the diminished importance of those terms in regards to the viewed search results. The query and the adjusted weights can be submitted to a search engine in order to obtain the refined search results. In this way, queries can be automatically refined without requiring user intervention.

In general, one aspect of the subject matter described in this specification can be embodied in methods that include the actions of providing an ordered plurality of first search results to a client device at a first point in time wherein the first search results are responsive to a first query received from the client device; detecting, at a second point in time following the first point in time, a lack of selection of any of the first search results by a user of the client device; in response to the detecting: identifying a plurality of the first search results that have been viewed by the user of the client device between the first point in time and the second point in time; obtaining a plurality of ordered second search results that are different from the first search results based on information associated with the first search results that were determining to have been viewed; providing the second search results to the client device before selection of any of the first search results by the user of the client device.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. Obtaining the plurality of ordered second search results can include revising the first search query to obtain a second search query based on, at least, the information associated with the first search results determined to have been viewed; and obtaining the second search results responsive to the second query. The first search results and the second search results can be provided in separate regions of a graphical user interface provided to the client device. Determining the plurality of the first search results that have been viewed can include receiving data from the client device indicative of scrolling behavior of the user of the client device; and determining the plurality of the first search results that have been viewed based on, at least, the received data. It can be determined, for a plurality of queries having a given number of terms, search result selection behavior for a plurality of users, wherein the search result selection behavior includes a plurality of points in time since a query of the given number of terms was submitted, and wherein each point in time is associated with a respective position number of a search result in an ordered list of search results responsive to a query of the given number of terms that was selected by the users at the point in time. Identifying the plurality of the first search results that have been viewed can include selecting a point in time from the search result selection behavior that corresponds to the second point in time; and determining the plurality of the first search results that have been viewed based on the respective position number associated with the selected point in time. The information can be one or more terms of the first search query or of an expanded version of the first search query, wherein each of the terms is associated with a respective weight and occurs in content of one or more resources that are identified by the plurality of the first search results that are determined to have been viewed. Obtaining the plurality of ordered second search results responsive to the second query can include adjusting the respective weight of one or more of the terms, wherein decreasing the respective weight reduces the importance of the term and wherein increasing the respective weight increases the importance of the term; providing the one or more respective weights to a search engine, wherein the search engine is configured to identify search results based on, at least, the terms and the provided weights; and after providing the one or more respective weights to the search engine, obtaining the plurality of second search results from the search engine. Revising the first search query to obtain the second search query can include adding or removing one or more terms from the first search query. The one or more terms can occur in content of one or more resources that are identified by the plurality of the first search results that have been viewed.

Particular embodiments of the subject matter described in this specification can be implemented so as to realize one or more of the following advantages. Search results can be automatically refined based on a user feedback model that estimates how many search results a user has viewed based on the elapsed time since the search results were provided to the user. Refined search results can be provided in place of original search results or as a supplement to the original search results.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example search system.

FIG. 2A shows a chart which illustrates an example user feedback model.

FIG. 2B illustrates a comparison of a function for a query having one term and a particular user's search result selection behavior.

FIG. 3A is an example graphical user interface for presenting search results.

FIG. 3B is an example graphical user interface for presenting refined search results.

FIG. 4 is a diagram of an example process for refining search results.

Like reference numbers and designations in the various drawings indicate like elements.

### DETAILED DESCRIPTION

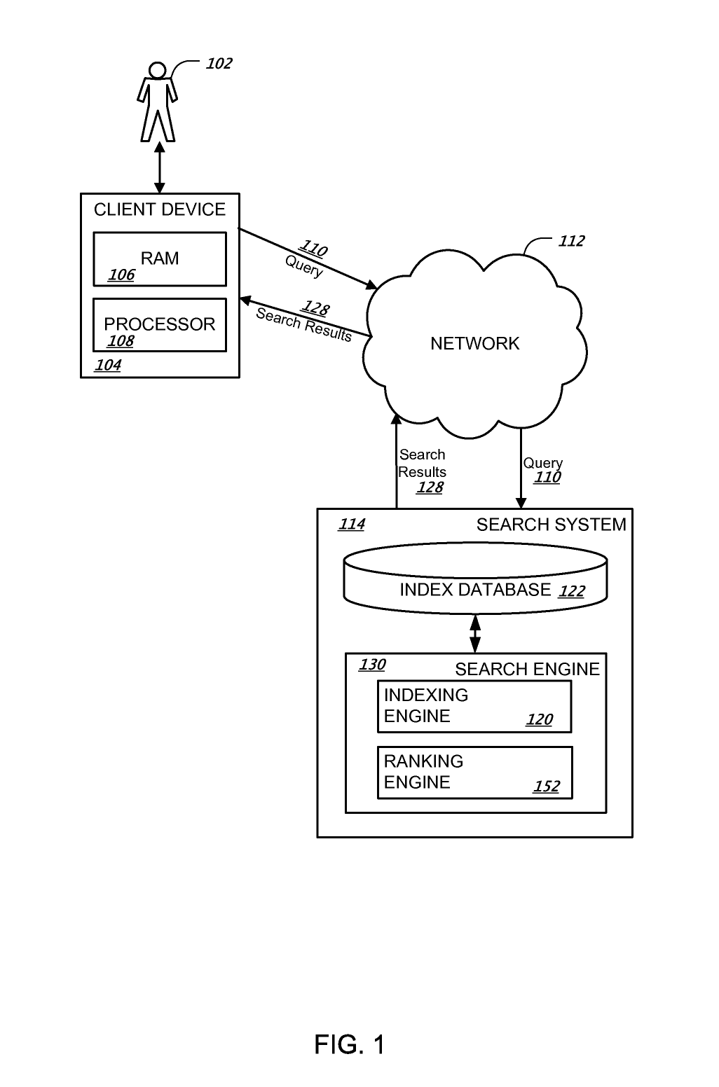

FIG. 1 shows an example search system 114. The search system 114 is an example of an information retrieval system implemented as one or more computer programs on one or more computers in one or more locations, in which the systems, components, and techniques described below can be implemented.

A user 102 can interact with the search system 114 through a client device 104. For example, the client device 104 can be a computer coupled to the search system 114 through a data communication network 112, e.g., local area network (LAN) or wide area network (WAN), e.g., the Internet, or a combination of networks. In some cases, the search system 114 can be implemented on the client device 104, for example, if a user installs an application that performs searches on the client device 104. The client device 104 will generally include a memory, e.g., a random access memory (RAM) 106, for storing instructions and data and a processor 108 for executing stored instructions. The memory can include both read only and writable memory.

A user 102 can use the client device 104 to submit a query 110 to a search system 114. A search engine 130 within the search system 114 performs a search to identify resources matching the query. When the user 102 submits a query 110, the query 110 may be transmitted through the network 112 to the search system 114. The search system 114 includes an index database 122 and the search engine 130. The search system 114 responds to the query 110 by generating search results 128, which are transmitted through the network to the client device 104 for presentation to the user 102, e.g., as a search results web page to be displayed by a web browser running on the client device 104. An example search result can include a web page title, a snippet of text or a portion of an image extracted from the web page, and the Uniform Resource Locator (URL) of the web page or other relevant resource, for example. A snippet of text from a web page or other resource can contain, for example, one or more contiguous (e.g., adjacent words or sentences) or non-contiguous portions of text.

In this specification, the term “database” will be used broadly to refer to any collection of data: the data does not need to be structured in any particular way, or structured at all, and it can be stored on storage devices in one or more locations. Thus, for example, the index database 122 can include multiple collections of data, each of which may be organized and accessed differently. Similarly, in this specification the term “engine” will be used broadly to refer to a software based system or subsystem that can perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

When the query 110 is received by the search engine 130, the search engine 130 identifies resources that satisfy the query 110. The search engine 130 will generally include an indexing engine 120 that indexes resources, an index database 122 that stores the index information, and a ranking engine 152 or other software that generates scores for the resources that satisfy the query 110 and that ranks the resources according to their respective scores.

A user feedback model is built. The user feedback model can be used to estimate the number of top-ranked search results that have been viewed by a user at a given point in time following submission of a query of a given number of terms. (A term is a word or a recognized combination of words, e.g., “new york”.) If the user has not selected any of the search results at the given point in time, the search results can be refined on the fly for the user based on the number of top-ranked search results estimated to have been already viewed by the user.

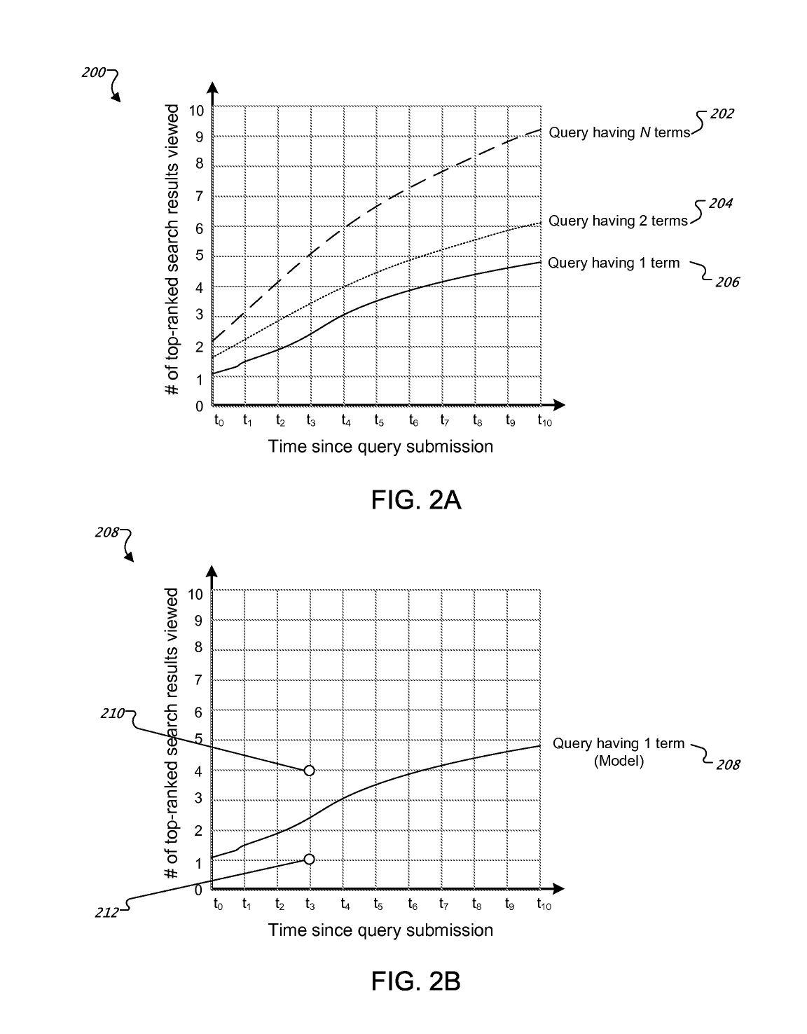

FIG. 2A shows a 200 chart which illustrates an example user feedback model. The horizontal axis is the amount of elapsed time since queries of a given term length were submitted by users (e.g., by users 102 of client devices 104) to a search engine, where t₀ represents the shortest elapsed time and t₁₀ represents the longest elapsed time. For example, the elapsed times could be intervals of 3 seconds. Other intervals are possible. Selection of a search result, e.g., using a mouse click or a finger touch, can cause the resource identified by the search result to be displayed. The vertical axis is the position of a user selected search result in an ordered list of search results where position 1 is the highest ranked search result and position 10 is the 10^{th} highest ranked search result. In this example, the user feedback model has been built for queries having a single term (function 206), two terms (function 204) and a N terms where N>2 (function 202). Each function can be used to estimate the number of top-ranked search results that have been viewed by users (on average) at a specified elapsed time since a query of a given term length was submitted. For example, in the case of function 204, at time t₁ users have viewed (on average) the two top ranked search results responsive to queries having two terms, and at time t₄ users have viewed (on average) the four top-ranked search results responsive to queries having two terms.

Because search results are presented to users in order from highest ranked to lowest ranked, it is assumed that when a user selects a search result the user has viewed the selected search result and those preceding it (i.e., those having a higher rank). This insight informs the building of the user feedback model. To determine the function for a query of a given length, data pertaining to historical user search activity can be analyzed to determine when users tend to select search results for queries of a given number of terms. Current user activity data can be collected from JavaScript™ programs that execute in web browsers and send the data to the search system 114, for example, or through other means.

Historical user activity data can be stored in a query log. A query log is a database that chronicles the search activity of users of the search system 114 in an anonymous fashion such that individual users are not identified. Records in the query log each contain, for example, the time of an activity, an identifier assigned to the computing device of the user performing the activity, the type of activity (e.g., a query submission by the user or a selection of a search result by the user), and either the query submitted in the case of a query submission or identification of the search result that was selected.

For a group of users and queries of a given term length, the query log is analyzed to determine the average time between the submission of queries having the given term length by the users and when the users selected search results at a given position. This can be done for a number of different search result positions in order to determine the function for the query of the given term length. In order to determine the time between the submission of a query of length two and selection of a search result at position five, for example, the query log is searched for a record that contains an activity of search result selection (for a query of length two) and that indicates that the search result selected was in position five. The time of this activity is noted and the query log is searched for a record that contains an activity of query submission that occurs most recently before the noted time and is for the same user device identifier and is for a query of length two. The time elapsed between the query submission and the search result selection is used with times for other users to calculate the average time for search results in position five.

Alternatively, or in addition, a user's scrolling behavior can be used to estimate when a user has completed viewing the displayed search results. By way of illustration, when a user scrolls search results such that a previously hidden search result appears (having a lower rank than search results above it), the scrolling action can be interpreted to mean that the user has viewed the new search result as well as all of the preceding (higher ranked) search results. Scrolling activity can be recorded in the query log and can include the rank position of the previously hidden search result.

FIG. 2B illustrates a comparison of a function for a query having one term and a particular user's search result selection behavior. In various implementations, the user feedback model can be adjusted to take into account how quickly or slowly a particular user selects search results or scrolls as compared to the user feedback model for queries of a given term length. Adjusting the user feedback model to individual users can improve the quality of automatic search result refinement which is described further below.

In this example, the function 208 illustrates the average number of search results viewed by users for queries having one term at different points in time. Point 210 indicates behavior of an particular user who is viewing results faster than the average user (based on the user's current search result selection or scrolling activity). At time t₃, the model indicates that users on average have viewed the top two search results, whereas the particular user has viewed four search results. Likewise, point 212 indicates behavior of an individual user who is viewing results slower than the average user (based on the user's current search result selection or scrolling activity). Again, at time t₃, the model indicates that users on average have viewed the top two search results whereas the particular user has viewed only one search result.

The model function can be modified to fit the user's current behavior, if information about the user's current behavior is available. That is, for example, if a particular user is on average viewing search results twice as fast as the model function would indicate, the model function can be compressed in the time direction by a factor of 2.0. In some implementations, information about a user's current behavior is used only if session data is available for a current session for a threshold minimum amount of time, e.g., 2, 5, 10, 20, or 30 minutes. In some implementations, the session data is limited to a maximum amount of time, e.g., the most recent 30, 60, 90, or 120 minutes.

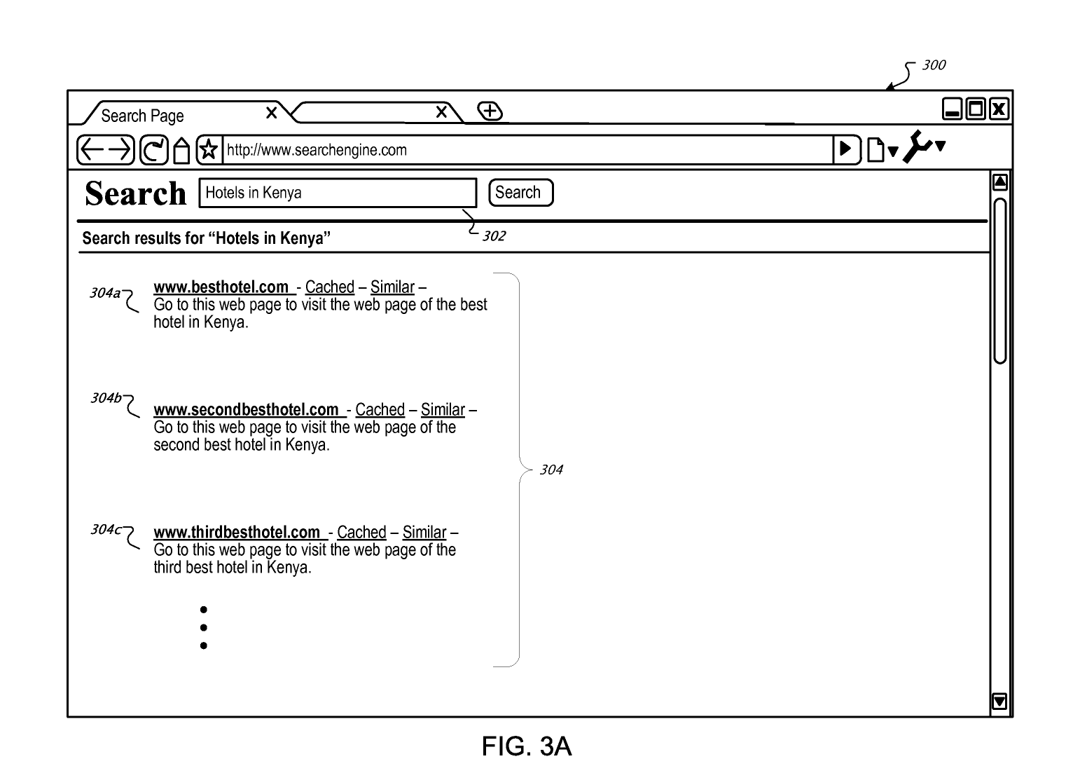

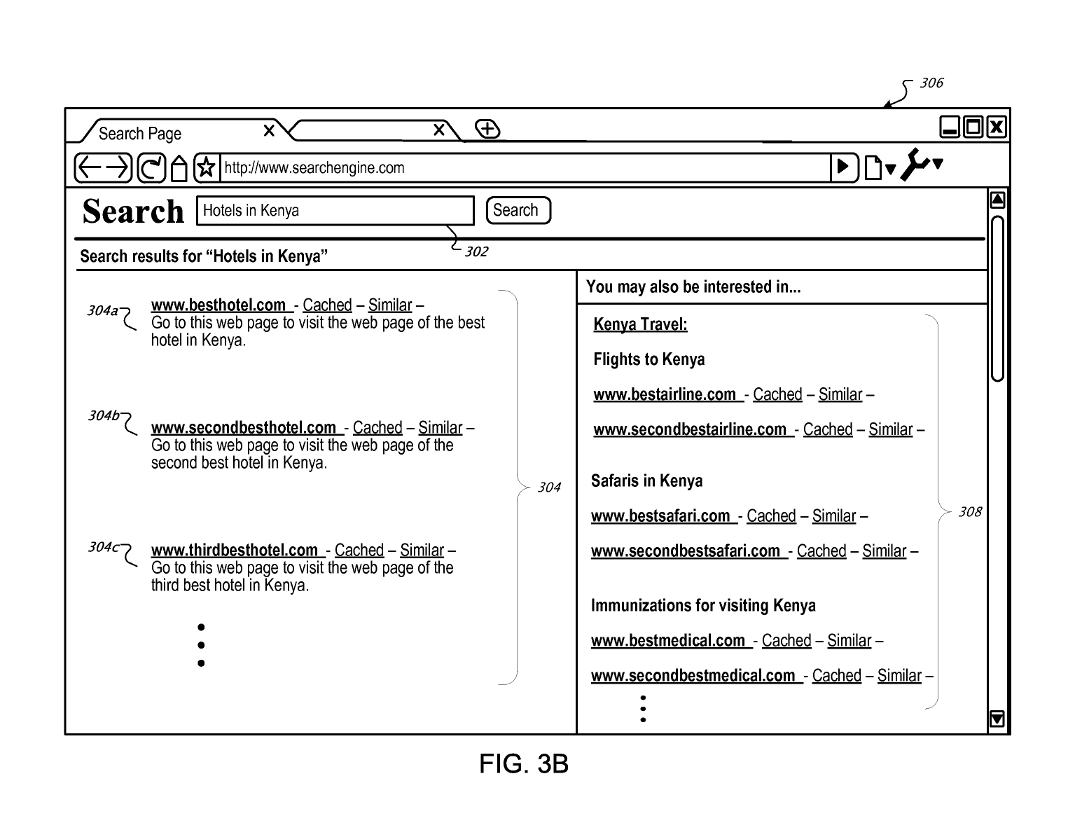

FIG. 3A is an example 300 graphical user interface for presenting search results from a search system. The user interface 300 can be presented by a web browser or other software executing on a client device (e.g., client device 104). The user interface 300 includes a text box 302 in which a user can enter a query. In this example, the query entered into text box 302 is “Hotels in Kenya”. The query has a term length of three. Ordered search results responsive to the query are presented in region 304 of the user interface 300. Search result 304a is the search result with the highest rank (first in the order). Search result 304b is the search result with the next highest rank (second in the order). Search result 304c is the search result with the third highest rank (third in the order). Selection of a search result (e.g., search result 304a) will cause the web browser or other software to present the web page identified by the selected search result.

In various implementations, the search system uses the user feedback model to automatically refine search results for users who have not selected any of the search results within a given period of time, e.g., 2, 3, 4, 5, 8, or 10 seconds. A user is deemed to have viewed and not selected particular search results—which may be referred to as “rejected” search results—based on the user feedback model, which may be a modified model made to fit the user's current behavior, as described above. The system uses information relating to the resources identified by the rejected search results—which may be referred to as “rejected” resources—or information derived from content of the rejected resources, or both, to reorder the search results or to refine the query to obtain different search results. The system can automatically provide the reordered search results or the newly obtained search results as refined search results to a client device of the user. The refined search results can either replace the currently presented search results (e.g. in region 304 of the user interface 300) or supplement the currently presented search results (e.g. in region 308 of the user interface 306 shown in FIG. 3B).

The system can derive key terms from the text of the content of rejected resources. A key term is a term that occurs in the content and has a tf-idf (term frequency-inverse document frequency) that exceeds a threshold.

In some implementations, the search results are refined by reordering them according to the number of key terms contained in the content of the resources identified by the search results. Recall that each search result has a position in the ordered list of search results. The position of a search result can be moved down the page (thereby lowering its rank) according to the number of key terms contained in content of the resource identified by the search result: the more key terms contained in the content of the resource, the more the position of the search result is likely to be moved down the page.

In further implementations, search results are automatically refined by obtaining new search results using a revised query. The terms of the original query submitted by the user were each automatically associated with a respective weight that indicated the importance of the term to the original query; the weights were used by the search system in the scoring of resources that were represented by search results. (In some cases, the original query may have been expanded to include one or more synonyms of one or more terms of the original query. The synonyms were also associated with respective weights.) One or more of the associated weights are adjusted to form the revised query. The associated weight of a query term is decreased (reducing its importance) if the term is a key term of a rejected resource. The associated weight of a query term is increased or left the same (increasing its importance) if the term or its synonym is not a key term of a rejected resource. The terms and associated weights of the revised query are then automatically processed by the search system (e.g., search system 114) which is configured to use the weights to obtain and rank revised search results. In some implementations, only the weights of synonyms are adjusted. In some implementations, key terms of rejected resources that are not original query terms are given a negative weight as query terms, causing resources containing those terms to be given a lower score and ranking The degree to which a weight is adjusted can be based on the number of times the associated query term occurs in the rejected of resources.

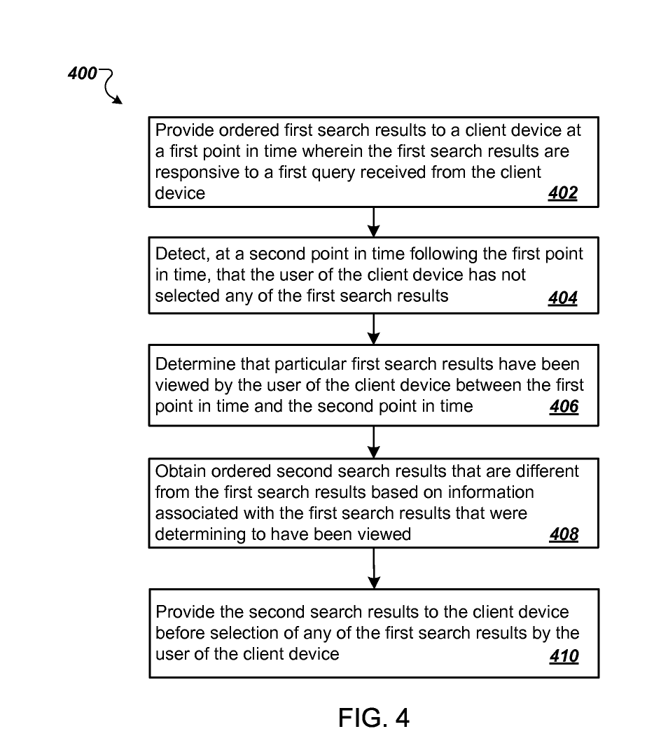

FIG. 4 is a diagram of an example process 400 for refining search results. For convenience, the process 400 will be described as being performed by a system of one or more computers located in one or more locations. For example, a search system, e.g., search system 114 of FIG. 1, can be used to perform the process 400.

The system (e.g., system 114) provides ordered search results to a client device (e.g., client device 104) at a first point in time; the search results are provided in response to a query received from the client device (step 402). The system detects, at a later second point in time, that the user of the client device has not selected any of the search results (step 404). In response to the detecting, the system determines that particular first search results have been viewed by the user of the client device between the first point in time and the second point in time (step 406) based on the user feedback model. The system then obtains refined search results based on information associated with the search results that were determining to have been viewed (step 408). Finally, the system provides the refined search results to the client device before the user selects of any of the original search results (step 410).

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method implemented by data processing apparatus, the method comprising:
providing, on a search result page, an ordered plurality of first search results to a client device at a first point in time, wherein the first search results are provided in response to a first query received from the client device;
detecting, at a second point in time following the first point in time, that a user of the client device has not selected any of the first search results; and
in response to the detecting:
identifying a plurality of rejected first search results deemed to have been viewed by the user of the client device between the first point tin time and the second point in time;
identifying a first search term included in the first query in accordance with the plurality of rejected first search results;
revising the first query by replacing the first search term with a second search term different from the first search term;
responsive to revising the first query:
automatically obtaining a plurality of ordered second search results that are different from the first search results by executing the revised first query, the second results including at least one search result not included in the first search results; and
automatically providing, on the search result page, the second search results to the client device before selection of any of the first search results by the user of the client device.

2. The method of claim 1, wherein the second point in time is selected in accordance with a total number of search terms included the first query.

3. The method of claim 2, wherein the second point in time is selected in accordance with historical user activity data specifying time differences between (A) submissions of queries having predefined numbers of search terms and (B) user selections of returned search results.

4. The method of claim 1, wherein the plurality of rejected first search results deemed to have been viewed by the user is identified by time difference between the first point in time and the second point in time.

5. The method of claim 1 wherein providing the second search results to the client device comprises:
replacing the plurality of rejected first search results with the second search results, or
supplementing the first search results with the second search results.

6. The method of claim 1 wherein identifying the plurality of rejected first search results comprises:
receiving scrolling data from the client device indicative of scrolling behavior of the user of the client device; and
determining the plurality of the first search results that have been viewed based at least on the scrolling data.

7. The method of claim 1, further comprising:
determining, for a plurality of queries having a given number of terms, search result selection behavior for a plurality of users, wherein the search result selection behavior comprises a plurality of points in time since a query of the given number of terms was submitted,
wherein each point in time is associated with a respective position number of a search result in an ordered list of search results responsive to a query of the given number of terms that was selected by the users at the point in time.

8. The method of claim 1 wherein identifying the plurality of rejected first search results comprises:
selecting a point in time from the search result selection behavior that corresponds to the second point in time; and
determining the plurality of the first search results that have been viewed based on the respective position number associated with the selected point in time.

9. The method of claim 1 wherein the information associated with the rejected first search results is one or more terms of the first search query or of an expanded version of the first search query, wherein each of the terms is associated with a respective weight and occurs in content of one or more rejected resources identified by rejected first search results.

10. The method of claim 9 wherein obtaining the plurality of ordered second search results responsive to the second query comprises:
adjusting the respective weight of one or more of the terms, wherein decreasing the respective weight reduces the importance of the term and wherein increasing the respective weight increases the importance of the term;
providing the one or more respective weights to a search engine, wherein the search engine is configured to identify search results based on, at least, the terms and the provided weights; and
after providing the one or more respective weights to the search engine, obtaining the plurality of second search results from the search engine.

11. A system comprising:
data processing apparatus programmed to perform operations comprising:
providing, on a search result page, an ordered plurality of first search results to a client device at a first point in time, wherein the first search results are provided in response to a first query received from the client device;
detecting, at a second point in time following the first point in time, that a user of the client device has not selected any of the first search results; and
in response to the detecting:
identifying a plurality of rejected first search results deemed to have been viewed by the user of the client device between the first point tin time and the second point in time;
identifying a first search term included in the first query in accordance with the plurality of rejected first search results;
revising the first query by replacing the first search term with a second search term different from the first search term;
responsive to revising the first query:
automatically obtaining a plurality of ordered second search results that are different from the first search results by executing the revised first query, the second results including at least one search result not included in the first search results; and
automatically providing, on the search result page, the second search results to the client device before selection of any of the first search results by the user of the client device.

12. The system of claim 11, wherein the second point in time is selected in accordance with a total number of search terms included the first query.

13. The system of claim 12, wherein the second point in time is selected in accordance with historical user activity data specifying time differences between (A) submissions of queries having predefined numbers of search terms and (B) user selections of returned search results.

14. The system of claim 1, wherein the plurality of rejected first search results deemed to have been viewed by the user is identified by time difference between the first point in time and the second point in time.

15. The system of claim 11 wherein providing the second search results to the client device comprises:
replacing the plurality of rejected first search results with the second search results, or
supplementing the first search results with the second search results.

16. The system of claim 11 wherein identifying the plurality of rejected first search results comprises:
receiving scrolling data from the client device indicative of scrolling behavior of the user of the client device; and
determining the plurality of the first search results that have been viewed based at least on the scrolling data.

17. The system of claim 11, wherein the operations further comprise:
determining, for a plurality of queries having a given number of terms, search result selection behavior for a plurality of users, wherein the search result selection behavior comprises a plurality of points in time since a query of the given number of terms was submitted,
wherein each point in time is associated with a respective position number of a search result in an ordered list of search results responsive to a query of the given number of terms that was selected by the users at the point in time.

18. The system of claim 11 wherein identifying the plurality of rejected first search results comprises:
selecting a point in time from the search result selection behavior that corresponds to the second point in time; and
determining the plurality of the first search results that have been viewed based on the respective position number associated with the selected point in time.

19. The system of claim 11 wherein the information associated with the rejected first search results is one or more terms of the first search query or of an expanded version of the first search query, wherein each of the terms is associated with a respective weight and occurs in content of one or more rejected resources identified by rejected first search results.

20. The system of claim 19 wherein obtaining the plurality of ordered second search results responsive to the second query comprises:
adjusting the respective weight of one or more of the terms, wherein decreasing the respective weight reduces the importance of the term and wherein increasing the respective weight increases the importance of the term;
providing the one or more respective weights to a search engine, wherein the search engine is configured to identify search results based on, at least, the terms and the provided weights; and
after providing the one or more respective weights to the search engine, obtaining the plurality of second search results from the search engine.

21. A computer program product stored on one or more non-transitory computer-readable mediums that, when executed by data processing apparatus, cause the data processing apparatus to perform operations comprising:
providing, on a search result page, an ordered plurality of first search results to a client device at a first point in time, wherein the first search results are provided in response to a first query received from the client device;
detecting, at a second point in time following the first point in time, that a user of the client device has not selected any of the first search results; and
in response to the detecting:
identifying a plurality of rejected first search results deemed to have been viewed by the user of the client device between the first point tin time and the second point in time;
identifying a first search term included in the first query in accordance with the plurality of rejected first search results;
revising the first query by replacing the first search term with a second search term different from the first search term;
responsive to revising the first query:
automatically obtaining a plurality of ordered second search results that are different from the first search results by executing the revised first query, the second results including at least one search result not included in the first search results; and
automatically providing, on the search result page, the second search results to the client device before selection of any of the first search results by the user of the client device.
